(19) United States
(12) Patent Application Publication
(10) Pub. No.: US 2004/0117634 A1
(43) Pub. Date: Jun. 17, 2004

(54) Method of calling up object-specific information

(76) Inventors: Michael Letterer, Hamburg (DE); Volker Timm, Pinneberg (DE); Rainer Lutz, Hamburg (DE)

Correspondence Address: Philips Electronics North America Corporation, Corporate Patent Counsel, PO Box 3001, Briarcliff Manor, NY, 10510, US

(21) Appl. No.: 10/475,162

(22) PCT Filed: Apr. 18, 2002
(86) PCT No.: PCT/IB02/01413

(30) Foreign Application Priority Data
Apr. 21, 2001 (DE) 101-19-549.4

(51) Int. Cl. H04L 9/00

(52) U.S. Cl. 713/182

(57) ABSTRACT

A method of calling up object-specific information on a data processing device which is connected to a communication device, wherein the object is provided with identification data, the identification data are read by the communication device, and an object-specific application is started on the data processing device on the basis of the identification data.

The invention relates to a method of calling up object-specific information on a data processing device which is connected to a communication device.

A main application for computers is the exchange of information via a network. The largest computer network at the moment is the Internet. The Internet is an electronic data network with a plurality of connected computers and computer networks. The connected computers can exchange information with one another by means of a service, for example the World Wide Web (“WWW”).

The architecture of the WWW corresponds to the conventional client-server model. The notions “client” and “server” define the actual function of a computer. A client computer requests data whereas a server computer supplies data. Thus the WWW service enables a server computer, for example a web server, to send a graphic web page as a piece of information to a connected client computer. A web page may be either a data block or a document which is written in a hyper text language such as the Hyper Text Markup Language (“HTML”), and which may contain text, graphical representations, and multimedia objects.

Each computer and each web page of the WWW is unequivocally identifiable by means of a uniform resource locator (“URL”). To indicate a certain web page, the client computer specifies the URL of this page in the form of a request, for example as a Hyper Text Transfer Protocol (“HTTP”) request. This request is passed on to the web server which supports this web page. When the web sever receives the request, it will send the web page to the client computer. The client computer then displays this web page by means of a browser. A browser is a special application program which carries out requests for web pages and the display of web pages.

Many web servers have been developed in the World Wide Web in the recent past by means of which traders and/or manufacturers advertise products and services and can also sell them. The product range varies from items such as music, which can be electronically downloaded by the customer via the Internet, to articles (domestic appliances, computers with accessories, electronic devices), which are delivered to the customer via traditional transport channels.

Besides the sale of products and services, further data such as, for example, detailed information on and descriptions of certain products or services are also made available in the form of web pages.

A major problem for a user of the Internet is often that it is difficult to find back web pages which were called up in the past. Another problem arises for an Internet user in the search for special information on a certain product or service. Since the Internet user does not know in most cases on which web page the information desired by him/her is present, he/she must often call up many different web pages in order to obtain the desired information. This is very time-consuming and expensive.

It is accordingly an object of the present invention to counteract the disadvantages of the prior art and to make available a method by which information on a certain object can be found quickly and effectively.

This object is achieved by means of a method of calling up object-specific information on a data processing device which is connected to a communication device in that an object is provided with identification data, which identification data are read by the communication device, and an object-specific application is started on the data processing device on the basis of said identification data. Advantageous embodiments of this method are defined in the dependent claims.

This method has the advantage that object-specific information can be called up at any time, in any location whatsoever. Furthermore, the most up-to-date information is always obtained for an object. A long search for this information, for example on the Internet, is not necessary.

In a preferred embodiment, the object is provided with a data carrier which contains the identification data.

The data carrier preferably is a transponder which operates in the radio frequency range. Alternatively, the data carrier may operate in other ranges which render possible a wireless or contactless transmission of data, for example in the ultrasound range or infrared range. It may be highly preferred that the data carrier is a silicon chip or a synthetic resin chip. The transponder may be fastened to the object so as to be visible from the outside, or inside the object so as to be invisible from the outside. Said data carrier contains identification data which render possible an unequivocal identification of the object. This may be, for example, a combination of symbols such as letters and/or numbers. Preferably, each object has a unique set of identification data. It is also possible that the data carrier comprises an encrypted data package. Alternatively, the data carrier may comprise a microprocessor or a cryptocontroller. In this embodiment, the data carrier is capable of carrying out complicated cryptographic authenticity checking algorithms or a deciphering of an encrypted data package.

Alternatively, the identification data may be laid down in a bar code system.

In a preferred embodiment, a physical body is used as the object.

An object, in particular a physical body, passes through various phases in its life cycle. First the object, for example a camera, a car part, a watch, a toy, a shoe, a piece of clothing, etc., is manufactured from various materials and processed. Once ready for sale, the object is obtained by a customer. The customer may be an end user, who obtains the object, for example, for his private use. The customer may alternatively be an intermediate trader who sells the bought object further, processes it further, or modifies it.

If the method according to the invention is to be optimally used, the object is provided with the identification data, preferably with a data carrier containing the identification data, as early as possible in its manufacturing process, preferably at the start thereof.

When the owner or user of the object wants to call up certain object-specific information, he will bring the object into the vicinity of a communication device which is capable of reading the identification data in a contactless manner. The communication device is furthermore connected to a data processing device. An object-specific application containing the object-specific information is started on the data processing device by means of the identification data.

The identification data may be advantageously transmitted to a database system via a link server system. The database system assigns application data to the object on the basis of the identification data. The link server system and the database system represent a connection to the object-specific information, for example in the Internet, and transmit the object-specific information and the application data to the data processing device. A certain object-specific application, for example a certain web page, a certain Internet site, or certain pages in a closed software system, is started on the data processing device by means of the application data.

It is preferred that the application data of the database system can be modified. Since the application data are managed in a database system, the application data and accordingly the object-specific information can be continuously updated. Furthermore, the application data can be adapted to special wishes and interests of the owner or user of the respective object by means of the database system. This renders it possible for the manufacturers and/or vendors of objects to market their objects in an effective manner, for example aimed at a certain target group. Personal data, for example the address of the owner or user, may also be entered on the relevant web page, Internet site, or page of a closed software system by means of the database. This may be particularly useful in the ordering of goods via the Internet, because the user or owner of the object then need not enter these data with each and every order.

The communication device may be, for example, a receiver or reader operating in the radio frequency range. The communication device may be present, for example, in the periphery of a computer such as, for example, a computer mouse or a mouse pad, or in the periphery of a TV set, for example a remote control or a set top box. The data processing device may be any data processing device with a screen and with Internet access or access to a closed software system. The data processing device may be, for example, a desktop computer, a laptop computer, a mobile telephone, or a personal digital assistant (PDA). The communication device and the data processing device may be present in a public space, for example in a kiosk, in a company building, or in a shop, for example at the cashier's desk, or in the private domain of the owner or user of an object. If the identification data are formed in a bar code system, the communication device will be a bar code reader.

In an advantageous embodiment of the invention, the object-specific application may be, for example, the calling up of a certain web page, of a certain Internet site, or a certain page in a closed software system.

Depending on the phase in product life, for example manufacture, sale, or use, of the object and depending on the nature of the object, widely differing data about the object will be of interest to the respective user or owner. Accordingly, widely differing object-specific applications may be started.

In a preferred embodiment of the invention, the object-specific information which can be called up is, for example, information about the production status, product information, information about the delivery status, quality data, service information, price information, manufacturer information, links to other web pages, links to other Internet sites, information on publicity and advertising, information on special offers, customer data, information on testing the genuineness of the object, or ordering information.

This method offers the manufacturers and vendors of certain objects an improved possibility of marketing their objects. It can also be made simpler to obtain an object and to obtain accessories to this object. Furthermore, trading and exchanging processes (“Business-to-Business, B2B”) and procurement processes (“e-procurement”) between companies can be simplified and speeded up.

Embodiments of the invention will be explained in more detail below, representing examples of how the invention may be implemented in practice.

Manufacturers, buyers, or users of branded products may use the method for testing the authenticity of objects. For this purpose, a high-grade object, for example a car part, an airplane part, a watch, sunglasses, leather goods, an article of clothing, or a piece of jewelry, is provided with a data carrier as early as possible in its manufacturing process. When the object is brought into the vicinity of a communication device, object-specific information such as product status, manufacturing information such as, for example, place of manufacture, quality data, or the authenticity of the object can be ascertained. Counterfeit objects can be quickly identified by this method.

Newspaper and magazine publishers, advertising agencies, and advertising and marketing companies can enhance their e-commerce activities and their Internet presence by means of this method. For this purpose, newspapers, magazines, prospectuses, or other printed items are provided with a data carrier. Newspaper publishers may thus link their printed items to their web pages on the Internet in an effective manner, thus offering the readers an improved service. A further application possibility is that parties interested in an object which is advertised in a printed medium can directly arrive at an Internet site with extensive product information, price information, and ordering information. Furthermore, the advertising measures may be adapted directly to the target audience or the special readers of the respective printed medium.

Manufacturers and/or vendors of games and toys are offered the possibility by the method of enhancing their offer around the game or toy. Games or toys are provided with data carriers for this purpose. Thus, for example, the owner or user of an adventure game may be enabled to call up the Internet sites of interactive game platforms in a particularly fast and simple manner in that he moves the game with the data carrier into the vicinity of a corresponding communication device. Furthermore, the user or owner of such a game as well as the user or owner of a toy, for example a doll or a cuddly animal, can obtain information about accessories for a special game or toy quickly and may possibly order it directly via the Internet. This method offers manufacturers or vendors of games and toys the possibility of marketing new games or toys and accessories thereof specially aimed at the target group. The called-up web pages or Internet sites are for this purpose provided with suitable pointers in the form of advertising or links.

The method offers cable TV companies or manufacturers of set top boxes a simple possibility of widening their product range, in particular as regards interactive TV programs. The cable TV companies or set top box manufacturers enable their customers to take part in their interactive TV programs in a simple and fast manner. For this purpose, objects connected with a cable TV company or a set top box manufacturer, for example a plastic card with the logo of the cable TV company or the set top box manufacturer, are provided with a data carrier. This object can be obtained by a customer and can be brought into the vicinity of a communication device which is connected to a data processing device. The corresponding interactive Internet pages of the cable TV company or the set top box manufacturer are then called up on the data processing device. The cable TV company or the set top box manufacturer has the possibility of attuning his offers and publicity measures specifically to the viewing habits of the customer. Furthermore, products and services, in particular in the region of e-commerce, of the cable TV company or the set top box manufacturer can be marketed in a targeted manner. For this purpose, the called-up Internet pages are provided with advertisements or links to other Internet pages. A further application is that cable TV companies or set top box manufacturers offer their customers “video on demand” or “pay per view” services.

In the field of photography and image processing, the method according to the invention may be used for ordering or exchanging digital images in a fast and simple manner, for example via the Internet. Prints of digital pictures may also be obtained in this manner, for example. To achieve this, a suitable object, for example a digital camera, a memory module of a digital camera, or a customer card is provided with a data carrier. When the owner or user of such an object moves it into the vicinity of a communication device which is connected to a data processing device, he may access, for example, an Internet site or a web page which renders it possible to obtain digital images, on which the owner or user of the object can offer his own digital images for exchange or sale, or on which he can order prints of digital images. Furthermore, products of the photo industry may be ordered via the Internet or information about the products may be called up.

Manufacturers of information carriers on which data are digitally stored, such as, for example, CDs (Compact Discs), DVDs (Digital Versatile Discs), or magnetic tapes, may use this method for preventing an unauthorized multiplication of these information carriers in the form of pirated copies. For this purpose the information carrier itself or its packaging is provided with the data carrier. Alternatively, a separate object on which the data carrier is provided, for example a plastic card or a sticker, may be added to the information carrier. In the case of a CD or a DVD, for example, the data carrier may be embedded in the inner portion of the CD or DVD surrounding the central hole, where usually no information in the conventional sense of the word is present.

In a possible embodiment, the data carrier comprises an encrypted data package, for example an encrypted algorithm, which allows of not only an identification, but also an authenticity check of the object.

If the buyer or owner of a CD, for example, wants to call up the digital data from a CD, he will bring the relevant data carrier into the vicinity of a communication device which is connected to a data processing device. The communication device reads the encrypted data package, deciphers it, and sends the deciphered data to the data processing unit, which carries out the authenticity check. If the authenticity check result is positive, a CD-specific application is started which enables the buyer or owner to call up the digital data from the CD.

In another possible embodiment, the data carrier comprises besides the encrypted data package a microprocessor capable of deciphering this data package. When the buyer or owner of the CD brings such a data carrier into the vicinity of the communication device, the communication device will read the deciphered data package and will send it to the data processing device, which carries out the authenticity check. If the test result is positive, a CD-specific application will be started which enables the buyer or owner to call up the digital data from the CD.

It is alternatively possible in both embodiments that the actual authenticity check of the information carrier is carried out not locally in the data processing device, but that the deciphered data package is transmitted via the link server system to a database system, and that the authenticity check takes place there.

If the entire identification and authenticity checking process need not be performed at each and every use of the CD, the CD-specific information and application data may be stored in the data processing device, for example on the data processing device of the buyer or owner of the CD. Alternatively, the data may be stored in a server, so that the customer will have access to the information and application data necessary for the use of the CD from several data processing devices.

In addition, the information carrier may comprise further protection mechanisms. Thus, for example, a comparison may be made between protection data which are present on the information carrier and protection data of the information carrier which are present on the data processing device.

An optimized protection against illegal multiplication can be achieved in conjunction with a conventional copying protection on the information carrier, for example defective sectors on the information carrier. Reading and/or copying of an information carrier can indeed not be prevented by the method according to the invention, but the information carrier can be used on a data processing device only if the data carrier is present.

1. A method of calling up object-specific information on a data processing device which is connected to a communication device in that an object is provided with identification data, which identification data are read by the communication device, and an object-specific application is started on the data processing device on the basis of said identification data.

2. A method as claimed in claim 1, characterized in that the object is provided with a data carrier which contains the identification data.

3. A method as claimed in claim 1, characterized in that a physical body is used as the object.

4. A method as claimed in claim 1, characterized in that
the identification data are transmitted to a database system via a link server system,
the database system assigns application data to the object on the basis of the identification data,
the link server system and the database system create a connection to the object-specific information, and
the object-specific information and the application data are transmitted to the data processing device via the link server system.

5. A method as claimed in claim 1, characterized in that the application data of the database system can be modified.

6. A method as claimed in claim 1, characterized in that the object-specific application called up is a web page, an internet site, or a page in a closed software system.

7. A method as claimed in claim 1, characterized in that the object-specific information called up is formed by information about the product status, product information, information about the delivery status, quality data, service information, price information, manufacturer information, links to other web pages, links to other Internet sites, information on publicity measures, information on special offers, customer data, information for testing the authenticity of the object, or ordering information.

8. A data carrier with identification data for calling up object-specific information on a data processing device which is connected to a communication device, wherein
the object is provided with identification data,
the identification data are read by the communication device, and
an object-specific application is started on the data processing device on the basis of the identification data.

9. A communication device for calling up object-specific information on a data processing device which is connected to a communication device, wherein
the object is provided with identification data,
the identification data are read by the communication device, and
an object-specific application is started on the data processing device on the basis of the identification data.
